(19) United States
(12) Patent Application Publication
(10) Pub. No.: US 2010/0124585 A1
(43) Pub. Date: May 20, 2010

(54) METHOD OF PRODUCING KOJI PELLETS

(76) Inventor: Hye Lim YOO, Fullerton, CA (US)

Correspondence Address: IPLA P.A., 3550 WILSHIRE BLVD., 17TH FLOOR, LOS ANGELES, CA, 90010, US

(21) Appl. No.: 12/416,456

(22) Filed: Apr. 1, 2009

(30) Foreign Application Priority Data
Nov. 14, 2008 (KR) 10-2008-0113611

(51) Int. Cl. A23L 1/20; A23P 1/12

(52) U.S. Cl. 426/46; 426/516; 426/473

(57) ABSTRACT

A method of producing Koji pellets comprises: mixing soybeans and grain powders; grinding the mixed soybeans and powders; and extruding the ground admixture into pellets using an extruder, wherein the soybean protein of the ground admixture is heat-denaturized.

### CROSS REFERENCE

This application claims foreign priority under Paris Convention and 35 U.S.C. §119 to each of Korean Patent Application No. 10-2008-0113611 filed Nov. 14, 2008 with the Korean Intellectual Property Office.

### BACKGROUND OF THE INVENTION

The present invention relates to Koji pellets, and more particularly to an improved method of producing Koji pellets maximizing enzyme generation with introduction of an extruder.

Conventional production of Koji pellets are exposed to contamination with germs in the course of raw material pre-treatment, resulting from a variety of reasons including poor mixing ratio of raw materials. To produce conventional Koji products, defatted soybean which is a main raw material of Koji products is added with high temperature steam 0.9˜6.0 Kg/cm² for protein denaturation. In case of wheat, it is pregelatinized and crushed at high temperature of over 130° C. to produce Koji; in case of wheat flour, hot water over 95° C. and high temperature steam 0.4˜1.20 kg/cm² are added for pregelatinization in producing Koji. In such conventional method, however, insufficient denaturation of defatted soybean, source of protein, and low coefficient of utilizing raw material due to enzyme and insufficiently homogenized pregelatinization of wheat and its quality decline by non-denatured raw material were the cause of low quality Koji.

In recent years, many attempts are made to raise the coefficient of utilizing raw material by means of high temperature, short time protein de-naturation, some of which are being practiced, but the rise of production cost along with more production facility requirement is the problem.

In addition, the cost becomes even higher owing to the rise of Koji material cost, yet the customers' demand for quality is constantly on the rise.

Korean Patent Publication No. 10-2002-0074421 to Iwasaki discloses a technique with which the strain of Aspergillus Orzae is inoculated to rice bran and aged to make Rice Bran Koji. Then the Aspergillus is sterilized with high heat and resultantly dry koji is made which is effective in preventing large intestine cancer; another technique is introduced to make powdered dry Koji made by grounding crop Koji which is made by inoculating the foregoing Aspergillus Orzae mixed with lactic acid bacteria to the mix of rice bran and crops.

Korean Patent Publication No. 10-2005-0040268 to Kim et al. discloses a technique to produce Ginseng Soybean Koji which comes out in a form of fermented dry soybeans made by inoculating 2˜3% Aspergillus Oryzae into the fermented soybeans after crushing soaked, steamed soybeans and mold proliferation being suppressed by mixing with ginseng powder.

Korean Patent Publication No. 10-0695410 to Jeong et al. discloses a technique to produce instant germinated soybean paste for cancer-resistant and oxidization-resistant food by means of germinating soybeans, making fermented soybeans, crushing the beans to get fermented soybean powder to which locoris and table salt are added before fermentation, heating, and filtration.

Korean Patent Publication No. 10-2004-0061992 to Lee et al. discloses a technique to make Koji for Red Pepper Paste in which the content of capsaicin that produces pungent taste is reduced by the function of enzyme secreted from seed Koji after red pepper powder is added at a stage of fermentation in the course of proliferating seed Koji in the steamed starch.

However, nowhere in the foregoing documents is described the method of producing superior Koji product as well as improving the effect of starch by making into pellets using raw material extruder and maximizing the enzyme activities by heat denaturing with protein raw material.

### SUMMARY OF THE INVENTION

The present invention is contrived to overcome the conventional problems. An objective of the prevent invention is to provide a production method of Koji pellets maximizing enzyme generation with introduction of an extruder.

Another objective is to provide products of quality Koji pellets produced in low cost.

To achieve these and other objectives, the present invention provides a method of producing Koji pellets, comprising: mixing soybeans and grain powders; grinding the mixed soybeans and powders; and extruding the ground admixture into pellets using an extruder, wherein the soybean protein of the ground admixture is heat-denaturized.

The method may further comprise: cooling down the extruded admixture to normal temperature (15° C.) and eliminating moisture from the extruded admixture; and proliferating Aspergillus Oryzae to the extruded admixture.

In an embodiment, the extruded admixture is gelatinized, and the admixing is maintained for about 45 to 50 hours under the temperatures of about 28° C. to 30° C., about 95% of humidity, and about 38% of moisture to maximize generation of enzymes.

Preferably, the enzymes are protease and amylase, and the pellets are multi-porous Koji pellets.

Although the present invention is briefly summarized, the full understanding of the invention can be obtained by the following drawings, detailed description, and appended claims.

### BRIEF DESCRIPTION OF THE DRAWINGS

These and other features, aspects and advantages of the present invention will become better understood with reference to the accompanying drawings, wherein:

FIG. 1 is a flow chart showing steps of production of Koji pellets according to the present invention.

### DETAILED DESCRIPTION OF THE INVENTION

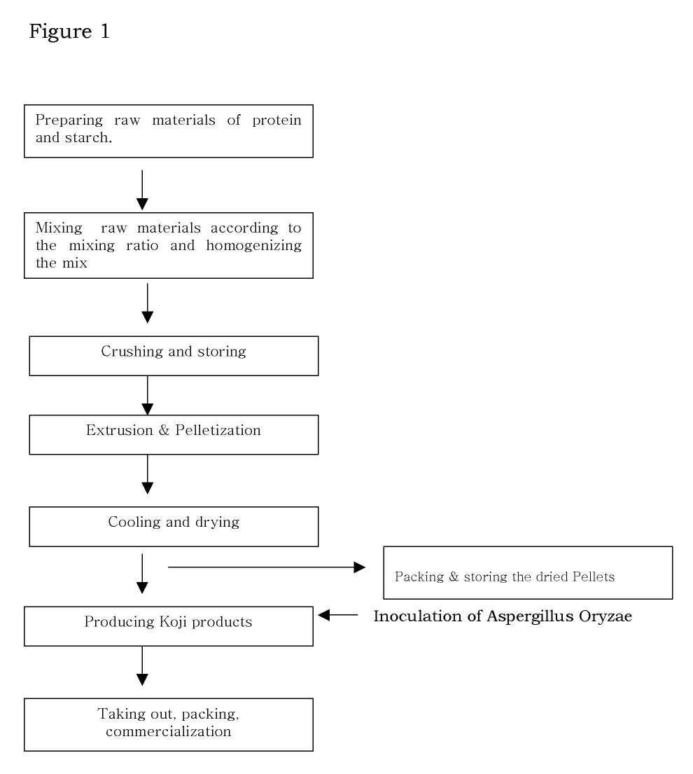

As shown in FIG. 1, a method of producing Koji pellets comprises steps of: mixing soybeans and grain powders; grinding the mixed soybeans and powders; and extruding the ground admixture into pellets using an extruder. Here, the soybean protein of the ground admixture is heat-denaturized.

The method may further comprise: cooling down the extruded admixture to normal temperature (15° C.) and eliminating moisture from the extruded admixture; and proliferating Aspergillus Oryzae to the extruded admixture.

In an embodiment, the extruded admixture is gelatinized, and the admixing is maintained for about 45 to 50 hours under the temperatures of about 28° C. to 30° C., about 95% of humidity, and about 38% of moisture to maximize generation of enzymes.

Preferably, the enzymes are protease and amylase, and the pellets are multi-porous Koji pellets.

The method of producing Koji Pellets reduces production cost while maintaining quality pellets with little heat source like steam, thereby maximizing utility of raw materials. The method maximizes enzyme generation on and around each surface area of the pellets and enables transforming the pellets into a multi-porous structure while suppressing proliferation of bacillus.

Further, the multi-porous structure of the pellets serves to well protect final products, for example, in the course of raw material conveyance. The multi-porous structure also helps proliferation of Aspergillus Oryzae.

### EXAMPLE 1

Step 1 is for material preparation. In this step, soybeans and grain powders are prepared considering a predetermined ratio of mixture of the materials. Soybeans may be replaced with beans. The ratio may be determined by weight and/or volume of the materials. Grain powers may be wheat powders.

Step 2 is for material mixture. In this step, the prepared materials are evenly mixed depending on variation of final Koji pellet products. A mixer may be used in this mixing step. The variation of final Koji pellet products is determined by a weight and/or volume ratio in material mixture.

Step 3 is for Grinding and Storage. In this step, the mixed materials are crushed and/or ground considering final Koji pellet products. The ground materials are stored in a storage tank.

Step 4 is for extrusion and pelletization. In this step, the mixed, stored materials are extruded into Koji pellets from the storage tank using an extruder with supply of moisture or steam. At this stage, the heat denaturization of soybean protein and gelatinization of the mixture starch are adjusted in accordance with characteristics of final Koji products. Further, fermentation and starch of the mixture may be controlled to meet predetermined values.

Step 5 is for cooling and drying. In this step, the extruded Koji pellets are cooled down to normal temperature (15° C.) using a cooler. At this time, the moisture is eliminated or dried out through vaporization. Temperature and ventilation may be adjusted to control the vaporization.

Step 6 is for packing of Koji pellets. In this step, the cooled-down Koji pellets are packed by a predetermined unit and conveyed to a warehouse.

In order to generate enzymes, in Step 4, Aspergillus Oryzae is admixed or inoculated to the extruded Koji pellets and the admixture is maintained for about 45 to 50 hours to maximize generation of enzymes like protease and amylase. During the hours, ventilation may be adjusted to maintain temperatures of about 28° C. to 30° C., about 95% of humidity, and about 38% of moisture in the admixture. Alternately, when the enzyme generation is maximized, the Koji pellets may be packed into final product units.

While the invention has been shown and described with reference to different embodiments thereof, it will be appreciated by those skills in the art that variations in form, detail, compositions and operation may be made without departing from the spirit and scope of the invention as defined by the accompanying claims.

What is claimed is:

1. A method of producing Koji pellets, comprising:
mixing soybeans and grain powders;
grinding the mixed soybeans and powders; and
extruding the ground admixture into pellets using an extruder, wherein the soybean protein of the ground admixture is heat-denaturized.

2. The method of claim 1, further comprising:
cooling down the extruded admixture to normal temperature (15° C.) and eliminating moisture from the extruded admixture.

3. The method of claim 1, further comprising:
proliferating Aspergillus Oryzae to the extruded admixture.

4. The method of claim 1, wherein the extruded admixture is gelatinized.

5. The method of claim 3, wherein the admixing is maintained for about 45 to 50 hours under the temperatures of about 28° C. to 30° C., about 95% of humidity, and about 38% of moisture to maximize generation of enzymes.

6. The method of claim 5, wherein the enzymes are protease and amylase.

7. The method of claim 1, wherein the pellets are multi-porous Koji pellets.
